(19) United States
(12) Patent Application Publication
(10) Pub. No.: US 2009/0024681 A1
(43) Pub. Date: Jan. 22, 2009

(54) FILTER CIRCUIT AND FILTERING METHOD FOR REMOVING CONSECUTIVE NOISE FROM SAMPLED DIGITAL SIGNALS

(75) Inventor: Kenjirou MATOBA, Miyazaki (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/166,665

(22) Filed: Jul. 2, 2008

(30) Foreign Application Priority Data
Jul. 18, 2007 (JP) 2007187014

(51) Int. Cl. G06F 17/10; G06F 7/02

(52) U.S. Cl. 708/207; 708/300

(57) ABSTRACT

A filter circuit removes noise from digital data which is successively input in synchronism with a sampling clock signal. The filter circuit serves to filter the digital data by calculating the average value of every two of the current, previous and twice previous values, determining one of the three average values that is closest to the previous filtered value at each time in synchronism with a sampling clock, outputting the current filtered value by performing an average operation on at least the closest one of the closest average value and previous filtered value. By this process, it is possible to effectively remove noise superimposed on consecutive samples, and also to make the waveform of the filtered output signal smooth.

### BACKGROUND OF THE INVENTION

1. Field of the Invention

The present invention relates to a filter circuit and a filtering method, and in particular, relates to a filter circuit and a filtering method capable of removing noise from digital data which is successively input in synchronism with a sampling clock signal.

2. Description of the Background Art

Generally, there are two techniques for removing noise superimposed on digital data as follows. One technique is to reduce the noise level by using the average of several samples, and the other is to remove noise by the use of a digital filter. For example, Japanese Patent Laid-Open Publication No. 311082/1995 discloses a noise removal process making use of a moving average method which is applied to rotating equipment. Another Japanese Patent Laid-Open Publication No. 2000-89805 discloses a technique of removing noise in the form of pulse, which solely occurs, by saving the current, previous and twice previous values of the input signal, and selecting the current value if the difference between the current and previous values is smaller than a predetermined threshold value, otherwise selecting the twice previous value.

However, in the conventional technique such as described in the Japanese '082 publication indicated above, the average arithmetic operation is performed on data involving noise, thus sometimes rendering this solution not effective depending upon the noise level. For example, in the case where the average arithmetic operation is performed over 10 data items while continuously receiving data items of magnitude “1” with one item of magnitude “10” involved, which is noise, the average arithmetic operation results in the averaged magnitude of (1×9+10)/10=1.9. In this case, the error appears very remarkable in relation to the signal level of “1” expected without noise. In the other way, if a digital filter is used, there is a problem that the circuit scale increases because of a number of necessary circuit elements such as multipliers, registers for implementing delay circuits, accumulation adders, registers for storing filter coefficients.

Because of this, in order to solve these problems, the Japanese '805 publication mentioned above discloses a filter device and a feedback control device capable of removing noise in the form of lone pulse. However, this technique cannot remove successive noise. Furthermore, U.S. Patent Application Publication No. US 2008/0094119 A1 to Matoba, the same applicant as the present patent application, discloses another technique of replacing a signal determined as an error signal by the previous signal. In this case also, a lone pulse noise can be removed, but not successive one.

### SUMMARY OF THE INVENTION

Taking into consideration the above circumstances, it is an object of the present invention to provide a filter circuit and a filtering method capable of effectively removing noise from digital data including continuous noise over successive sampling intervals.

It is another object of the present invention to provide a filter circuit and a filtering method capable of effectively removing noise from digital data and obtain a smoothed output waveform of the digital data as filtered.

In accordance with the present invention, a filter circuit for filtering an input signal in synchronism with a clock signal to output a first output signal comprises: a first delay circuit operative in synchronism with the clock signal to produce at least three signals which are delayed in relation to the input signal by respective periods corresponding to one clock, two clocks and three clocks, respectively; an average circuit averaging every two of the three delayed signals to calculate three average values; a differential circuit operative to the first output signal for calculating a difference each of the three average values calculated by said average circuit from the first output signal to produce three differential value; a minimum value determination circuit determining which of the three differential values calculated by the differential circuit is the minimum differential value to output a second output signal which indicates the average value corresponding to the minimum differential value; a selector selecting one of the three average values which corresponds to the second output signal to output the selected average value as a third output signal; and a second delay circuit outputting the third output signal as the first output signal in synchronism with the clock signal, whereby every two of the three delayed signals are averaged, and one of the average values is determined which is closest to the previous value of the first output signal, the average value determined being output as the current value of the first output signal.

In accordance with the present invention, a filtering method of filtering an input signal and outputting a first output signal in synchronism with a clock signal comprises: a first step of producing three signals which are delayed in relation to the input signal by respective periods corresponding to one clock, two clocks and three clocks, respectively, in synchronism with the clock signal; a second step of averaging every two of the three delayed signals to calculate three average values; a third step of calculating a difference of each of the three average values calculated in the second step from the first output signal to produce three differential values; a fourth step of determining which of the three differential values calculated in the third step is the minimum differential value to output a second output signal which indicates the average value corresponding to the minimum differential value; a fifth step of selecting one of the three average values which corresponds to the second output signal to output the selected average value as a third output signal; and a sixth step of outputting the third output signal as the first output signal in synchronism with the clock signal, whereby every two of the three delayed signals are averaged, and one of the average values is determined which is closest to the previous value of the first output signal, the average value determined being output as the current value of the first output signal.

Further in accordance with the present invention, a filter circuit for removing noise from digital input data in the form of series of sampled values to produce digital output data in the form of series of filtered values comprises: a delay unit successively receiving the sampled values to output a current, previous and twice previous values at each time in synchronism with a sampling clock; an average circuit receiving the current, previous and twice previous values to calculate the average value of every two of the current, previous and twice previous values to output the three average values calculated; a determination circuit determining one of the three average values that is closest to the previous filtered value of the digital output data at each time in synchronism with a sampling clock; and an output circuit calculating the filtered value of the digital output data by performing an averaging operation of the sampled values of which the closest average value is calculated.

By this configuration, while the circuit configuration is relatively simple, it is possible not only to remove noise superimposed on a sample but also to remove noise superimposed on consecutive samples in an effective manner.

### BRIEF DESCRIPTION OF THE DRAWINGS

The objects and features of the present invention will become more apparent from consideration of the following detailed description taken in conjunction with the accompanying drawings in which:

FIG. 1 is a circuit diagram schematically showing the configuration of a noise removing circuit which is a filter circuit in accordance with an illustrative embodiment of the present invention;

FIG. 2 is an explanatory chart for useful for understanding the operation of the noise removing circuit shown in FIG. 1;

FIG. 3 plots the waveforms of an example of input signal with continuous noise superimposed and the corresponding filtered output signal passed through a conventional noise removing circuit;

FIG. 4 plots, like FIG. 3, the waveforms of the same example of input signal with continuous noise superimposed as FIG. 3 and the corresponding filtered output signal of the noise removing circuit when the input signal is input to the noise removing circuit in accordance with the embodiment shown in FIG. 1;

FIG. 5 is a circuit diagram, like FIG. 1, schematically showing the configuration of a noise removing circuit which is a filter circuit in accordance with an alternative embodiment of the present invention;

FIG. 6 is an explanatory view, like FIG. 2, useful for understanding the operation of the noise removing circuit shown in FIG. 5;

FIG. 7 plots the waveforms of an example of sinusoidal input signal with noise superimposed and the corresponding filtered output signal passed through the noise removing circuit shown in FIG. 1;

FIG. 8 shows responses of the noise removing circuit of the embodiment shown in FIG. 1 to the same example of input signal as FIG. 7;

FIG. 9 plots, like FIG. 7, the waveforms of the example of sinusoidal input signal with noise superimposed and the corresponding filtered output signal passed through the noise removing circuit shown in FIG. 5; and

FIG. 10 shows, like FIG. 8, responses of the noise removing circuit shown in FIG. 5 to the same example of input signal as FIG. 9.

### DESCRIPTION OF THE PREFERRED EMBODIMENTS

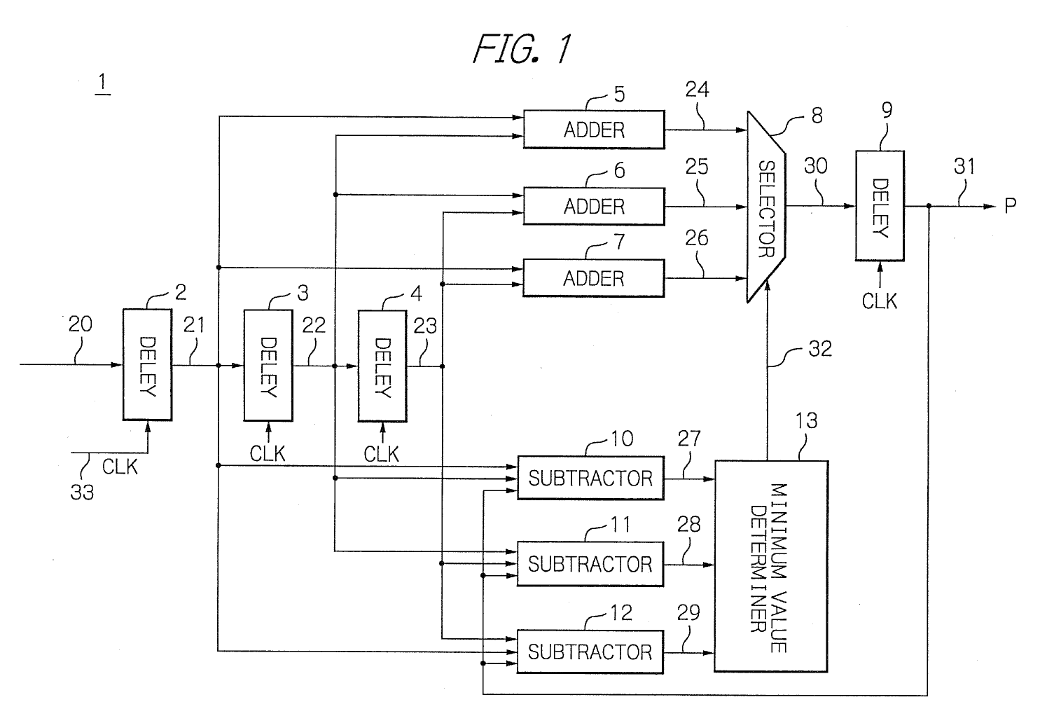

In what follows, a noise removing circuit in accordance with preferred embodiments of the present invention will be described with reference to the accompanying drawings. FIG. 1 is a schematic circuit diagram showing the noise removing circuit 1 in accordance with the present embodiment. Components or elements not relevant to understanding the invention will be neither described nor shown merely for the sake of simplicity.

The noise removing circuit 1 is a filter circuit which serves to filter an input signal 20 received to remove noise from the input signal 20 to output a resultant output signal (P) 31. The noise removing circuit 1 includes three delay circuits 2, 3 and 4 connected in series to each other, corresponding three adders 5, 6 and 7 connected in parallel to each other, and corresponding three subtractors 10, 11 and 12 also connected in parallel to each other. The subtractors 10, 11 and 12 are connected to a minimum value determiner 13 to output subtraction results 27, 28 and 29 to the minimum value determiner 13. On the other hand, the adders 5, 6 and 7 have the output terminals thereof connected correspondingly to three input terminals of a selector 8, which has its single output terminal 30 connected to another delay circuit 9. The delay circuits 2, 3, 4 and 9 are given a sampling clock signal (CLK) 33 of a predetermined frequency so as to operate in synchronism with the sampling clock signal 33. In the description, signals are designated with the reference numerals of connections conveying the signals.

The delay circuit 2 includes, for example, a D-type flip-flop which operates in synchronism with the sampling clock signal 33 to delay the input signal 20 input from the noise removing circuit 1 by the period corresponding to one clock and output the delayed signal as an output signal 21. Similarly, the delay circuit 3 includes a D-type flip-flop which operates in synchronism with the sampling clock signal 33 to delay the output signal 21, which is input from the delay circuit 2 in the preceding stage, by one clock and output the delayed signal as an output signal 22. Thus, the output signal 22 is delayed in respect to the input signal 20 by the period corresponding to two clocks. Likewise, the delay circuit 4 includes a D-type flip-flop which operates in synchronism with the sampling clock signal 33 to delay the output signal 22, which is input from the delay circuit 3 in the immediately preceding stage, by one clock and output the delayed signal as an output signal 23. The delay time of the output signal 23 with respect to the input signal 20 is the period corresponding to three clocks.

Needless to say, the D-type flip-flops for use in making up the delay circuits 2, 3 and 4 are provided in the same number as the number of bits of the input signal 20.

The adder 5 is an averaging circuit which is adapted to receive the output signals 21 and 22 of the delay circuits 2 and 3, and calculate the average of both output signals. More specifically, the calculation of (output signal 21+output signal 22)/2 is performed, and the calculation result is output as an output signal 24. Likely, the adder 6 is an average circuit adapted to receive the output signals 22 and 23 of the delay circuits 3 and 4, and calculate the average of both output signals. Specifically, the calculation of (output signal 22+output signal 23)/2 is performed, and the calculation result is output as an output signal 25. Furthermore, the adder 7 is also an average circuit adapted to receive the output signals 21 and 23 of the delay circuits 2 and 4, and calculate the average of the two input values. Namely, the calculation of (output signal 21+output signal 23)/2 is performed, and the calculation result is output as an output signal 26.

The subtractor 10 is a differential circuit which is adapted to receive the filtered output signal 31 of the delay circuit 9, as will be described below, and the output signals 21 and 22 of the delay circuits 2 and 3, subtract the average value between the output signals 21 and 22 from the filtered output signal 31, and calculate the absolute value 27 of the subtraction result. That is to say, the subtractor 10 performs the arithmetic operation of |output signal 31−(output signal 21+output signal 22)/2|, and outputs the result as an output signal 27. Likewise, the subtractor 11 is a differential circuit which is adapted to receive the filtered output signal 31 of the delay circuit 9, and the output signals 22 and 23 of the delay circuits 3 and 4, subtract the average value between the output signals 22 and 23 from the filtered output signal 31, and calculate the absolute value 28 of the subtraction result. That is, the subtractor 10 performs the arithmetic operation of |output signal 31−(output signal 22+output signal 23)/2|, and outputs the result as an output signal 28. Furthermore, the subtractor 12 is also a differential circuit which is adapted to receive the filtered output signal 31 of the delay circuit 9, and the output signals 21 and 23 of the delay circuits 2 and 4, subtract the average value between the output signals 21 and 23 from the filtered output signal 31, and calculate the absolute value 29 of the subtraction result. Namely, the subtractor 10 performs the arithmetic operation of |output signal 31−(output signal 21+output signal 23)/2|, and outputs the result as an output signal 29.

The minimum value determiner 13 is adapted for receiving the output values 27, 28 and 29 of the subtractors 10, 11 and 12, determines the minimum value of the output values 27, 28 and 29, and identifies either one of the subtractors 10, 11 and 12 which outputs that minimum value to output a minimum value calculating subtractor indication signal 32 indicative of such one subtractor. In the present illustrative embodiment, each of the subtracters 10, 11 and 12 is thus configured to obtain the absolute value of the difference between the output signal 31 and the average value of respective two of the output signals 21, 22 and 23. Alternatively, however, the minimum value determiner 13 may be adapted to obtain such an absolute value when determining the one subtracter.

The selector 8 is a three-out-of-one selector circuit which is adapted to receive the output values 24, 25 and 26 of the adders 5, 6 and 7, and the minimum value calculating subtractor indication signal 32 which is output from the minimum value determiner 13, to output either one of the received values 24, 25 and 26 in response to the minimum value calculating subtractor indication signal 32. More specifically, if the minimum value calculating subtractor indication signal 32 indicates the subtractor 10, then the selector 8 selects and outputs the output value 24 of the adder 5 as the output value 30. Similarly, if the minimum value calculating subtractor indication signal 32 indicates the subtracter 11, then the selector 8 selects and outputs the output value 25 of the adder 6 as the output value 30. Likewise, if the minimum value calculating subtractor indication signal 32 indicates the subtractor 12, then the selector 8 selects and outputs the output value 26 of the adder 7 as the output value 30.

The delay circuit 9 located at the output stage of the noise removing circuit 1 is adapted to receive the output value 30 of the selector 8 as a selected output value, and produce the output signal 31 in synchronism with the clock signal 33 to output the output signal as a noise-free, i.e. filtered output signal. The delay circuit 9 can be implemented by a D-type flip-flop.

With the illustrative embodiment, the delay circuits and adders are adapted to deal with a bit of data merely for simplicity. The present invention is however not restricted to such a specific configuration, but may be applicable to an application handling multiple bits of data input and output. Specifically, those circuit components may be arranged in parallel corresponding to the number of bits to be dealt with. The delay circuits, adders, subtractors, minimum value determiner, selector and connection lines described above may be designed to handle a desired type of numerical data, such as an integral type or a floating-point type.

In operation, when an input signal 20 is input to the delay circuit 2 at the input stage, the delay circuit 2, operative in response to the sampling clock signal 33, delays the input signal 20 by the period corresponding to one clock to output the delayed signal 21. The delayed signal 21 is in turn input to the delay circuit 3 at the following stage, which operates in synchronism with the sampling clock signal 33 to delay the output signal 21 by the period corresponding to two clocks in respect to the input signal 20 to output a resultant signal 22, which is in turn input to the delay circuit 4. The delay circuit 4 operates in response also to the sampling clock signal 33 to delay the input signal 22 by the period corresponding to three clocks with respect to the input signal 20, and outputs the delayed signal 23.

Now, the adder 5 averages the input signals 21 and 22. Similarly, the adder 6 averages the input signals 22 and 23. Likewise, the adder 7 averages the input signals 21 and 23.

On the other hand, the subtractor 10 subtracts from the filtered output signal 31 of the delay circuit 9 the average value between the output signals 21 and 22 of the delay circuits 2 and 3, and calculates the absolute value 27 of the subtraction result, i.e. performs the arithmetic operation of |output signal 31−(output signal 21+output signal 22)/2|, to output the resultant output signal 27. Likewise, the subtractor 11 subtracts from the filtered output signal 31 of the delay circuit 9 the average value between the output signals 22 and 23 of the delay circuits 3 and 4, and calculates the absolute value 28 of the subtraction result, i.e. performs the arithmetic operation of |output signal 31−(output signal 22+output signal 23)/2|, to output the resultatn output signal 28. The subtractor 12 subtracts from the filtered output signal 31 of the delay circuit 9 the average value between the output signals 21 and 23 of the delay circuits 2 and 4, and calculates the absolute value 29 of the subtraction result, i.e. performs the arithmetic operation of |output signal 31−(output signal 21+output signal 23)/2|, to output the result as an output signal 29.

The minimum value determiner 13 determines which one of the subtractors 10, 11 and 12 which outputs the minimum value of the output data 27, 28 and 29 from the subtractors 10, 11 and 12, and outputs a minimum value calculating subtractor indication signal 32 indicative of such one subtractor.

The selector 8 is responsive to the minimum value calculating subtracter indication signal 32, when output from the minimum value determiner 13, and selects corresponding one of the output values 24, 25 and 26 of the adders 5, 6 and 7, to output the selected value on its output 30. For example, when the minimum value calculating subtractor indication signal 32 indicates the subtracter 10, the selector 8 selects and outputs the output value 24 of the adder 5 corresponding thereto. When the indication signal 32 indicates the subtracter 11, the selector 8 selects and outputs the output value 25 of the adder 6 corresponding thereto. When the indication signal 32 indicates the subtractor 12, the selector 8 selects and outputs the output value 26 of the adder 7 corresponding thereto. The resultant output value 30 is input to the delay circuit 9 on the final stage. The delay circuit 9 is in response to the clock signal 33 and produces the filtered output signal 31 ultimately from the filter circuit 1.

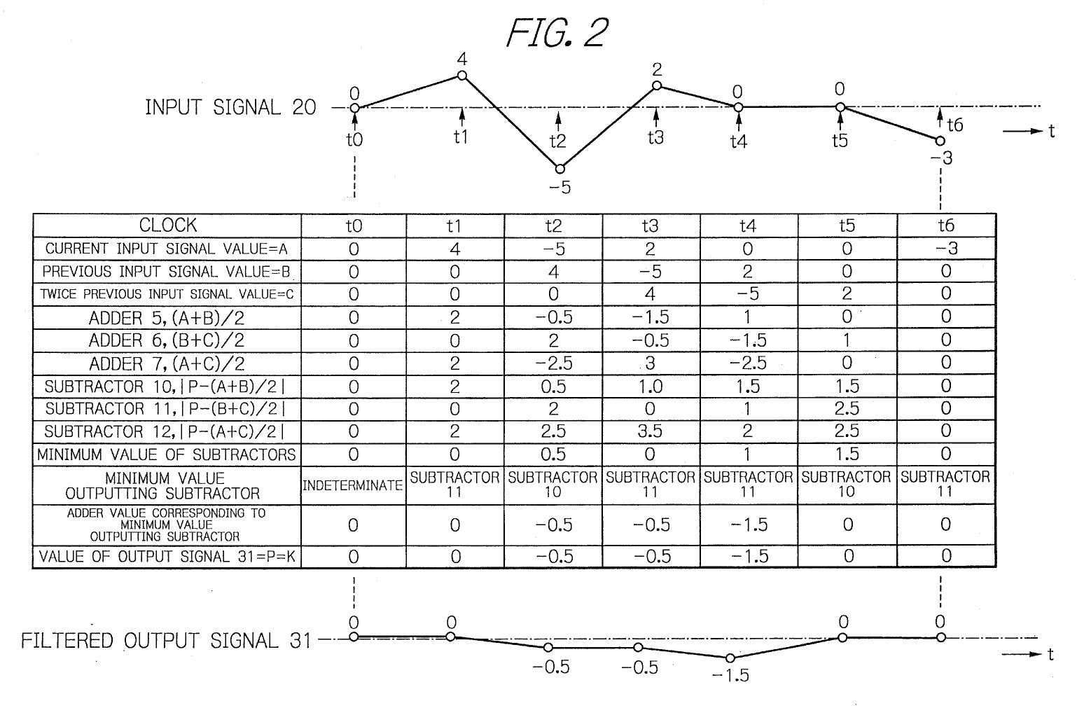

The operation of the noise removing circuit 1 will be described more in detail with reference to FIG. 2. In this case, as illustrated in the uppermost line in FIG. 2, although the input signal 20 would take in its nature, if including no noise, its level “0” at every time point from t0 to t6 in synchronism with the clock signal, there are noise signals of level 4 at time t1, level −5 at time t2, level 2 at time t3 and level −3 at time t6. For the sake of clarity in description here, the output of the delay circuit 2 is represented by the current input signal value A, the output of the delay circuit 3 by the previous input signal value B, and the output of the delay circuit 4 by the twice previous input signal value C. The output value of the selected adder is represented by K, and the filtered output signal 31 is referred to as P.

The adder 5 performs the operation (A+B)/2. Likewise, the adder 6 performs the operation (B+C)/2, and the adder 7 performs the operation (A+C)/2. Furthermore, the subtractor 10 performs the operation |P−(A+B)/2|. Similarly, the subtractor 11 performs the operation |P−(B+C)/2|, and the subtractor 12 performs the operation |P−(A+C)/2|.

In this case, at time t2, A=−5, B=4 and C=0. At this time, the output value of the adder 5 is (A+B)/2=−0.5, the output value of the adder 6 is (B+C)/2=2, and the output value of the adder 7 is (A+C)/2=−2.5. On the other hand, the output value of the subtractor 10 is |P−(A+B)/2|=0.5, the output value of the subtractor 11 is |P−(B+C)/2|=2, and the output value of the subtractor 12 is |P−(A+C)/2|=2.5.

Next, the minimum value determiner 13 determines which subtractor outputs the minimum value. In this example, the minimum value determiner 13 determines that the subtractor 10 outputs the minimum value, i.e. 0.5, and outputs the minimum value calculation subtractor identifier signal 32 indicative of this fact to the selector 8. When receiving the minimum value calculation subtractor identifier signal 32, the selector 8 selects the output value K=−0.5 of the corresponding adder 5 as the output value 30. It is noted that, if the subtractor 10 outputs the minimum value, the selector 8 selects the output value 24 of the adder 5; if the subtractor 11 outputs the minimum value, the selector 8 selects the output value 25 of the adder 6; and if the subtractor 12 outputs the minimum value, the selector 8 selects the output value 26 of the adder 7.

In this example, next, the output value K=−0.5 of the adder 5 selected by the selector 8 is input to the delay circuit 9 at the output stage, and the delay circuit 9 produces the output signal 31 in synchronism with the clock signal 33, and outputs this output signal as the filtered output signal 31.

The operation of the respective elements has been described above at time t2 defined by the clock signal 33. FIG. 2 also illustrates the operation at times t0 through t6.

If the minimum value determiner 13 determines that the subtractor 10 outputs the minimum value at a given time, then the minimum value determiner 13 necessarily determines at the next time that the output value of the subtractor 11 outputs the minimum value. As a result, in that case, the same output signal 31 is output in synchronism with the successive clock signals. The reason will read as follows.

When the minimum value determiner 13 determines that the output value 27 of the subtractor 10 outputs the minimum value, at time t2 in the case of above example, the output value of the adder 5, i.e. (A+B)/2, is output as the output signal 31 (=P). In synchronism with the next clock signal, at the next time t3 in the case of above example, the previous output value B of the delay circuit 3 is shifted to the delay circuit 4 as the current output value C, and the previous output value A of the delay circuit 2 is shifted to the delay circuit 3 as the current output value B. As a result, at time t3, the current output value of the subtractor 11 is equal to |P−(B+C)/2|, where P is the previous value of (A+B)2, and (B+C)2 is also equal to the previous value of (A+B)2, so that the subtractor 11 necessarily outputs a value of “0”. The minimum value determiner 13 therefore necessarily determines that the output value 28 of the subtractor 11 is minimum, unless the current input value C is the previous input value B or the twice previous input value C by coincidence, since the output value of the other subtracters is larger than “0”. The output signal 31 (=P) is then the output value of the adder 5, i.e. (B+C)/2 which is equal to (A+B)/2. Namely, the value of the output signal 31 at time t3 is equal to the value at time t2. This is true also at times t5 and t6.

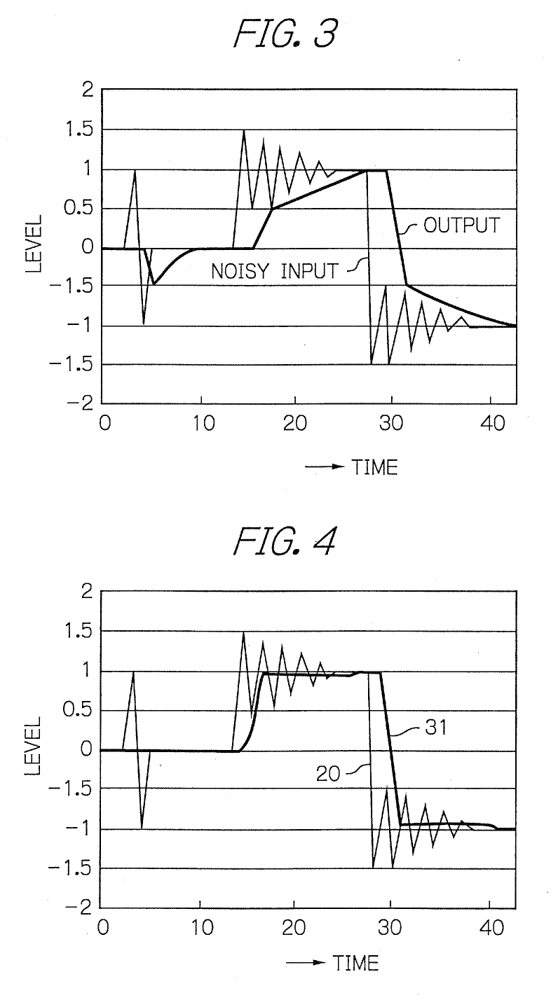

As illustrated in FIG. 2, by comparing the input signal 20 with the filtered output signal 31 from times t0 to t6, it will be understood that the waveform of the input signal 20 with continuous noise superimposed is filtered by substantially removing noise as the filtered output signal 31. FIG. 3 plots the waveforms of an example of input signal with continuous noise superimposed and the corresponding filtered output signal of a conventional noise removing circuit. FIG. 4 plots the waveforms of the same example of input signal with continuous noise superimposed as FIG. 3 and the corresponding filtered output signal 31 of the noise removing circuit 1 when the input signal is input to the noise removing circuit in accordance with the present embodiment as the input signal 20. As understood from FIGS. 3 and 4, the noise removing circuit 1 of the present embodiment can effectively remove noise even though the input signal 20 includes continuous noise.

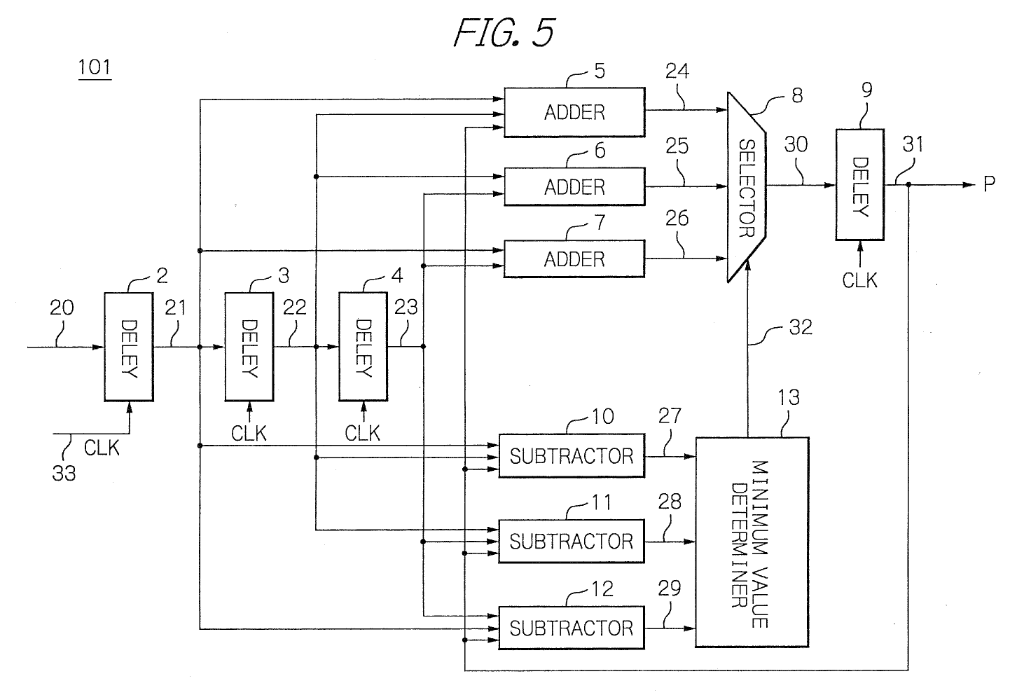

Next, with reference to FIG. 5, the configuration of a noise removing circuit 101 will be described in accordance with an alternative embodiment of the present invention. The noise removing circuit 101 of this alternative embodiment is substantially identical to the noise removing circuit 1 of the previous embodiment except for the following point. Namely, in the case of previous embodiment, the output signals 21 and 22 of the delay circuits 2 and 3 are input to the adder 5, and the adder 5 calculates the average value of the output signals 21 and 22 of the delay circuits 2 and 3. By contrast, in the instant alternative embodiment, the adder 5 receives the filtered output signal 31, and the output signals 21 and 22 of the delay circuit 2 and 3, and performs the calculation of {filtered output signal 31+(output signal 21 of delay circuit 2+output signal 22 of delay circuit 3)/2}/2.

Next, the operation of the noise removing circuit 101 in accordance with the alternative embodiment will be described. The operation of the noise removing circuit 101 is substantially identical to the operation of the noise removing circuit 1 of the previous embodiment except for the following points. Namely, whereas the adder 5 calculates the average value of the output signals 21 and 22 of the delay circuits 2 and 3 in the previous embodiment, the adder 5 of the present alternative embodiment performs the calculation of {filtered output signal 31+(output signal 21 of delay circuit 2+output signal 22 of delay circuit 3)/2}/2.

Additionally, in the previous embodiment, if the minimum value determiner 13 determines that the subtractor 10 outputs the minimum value at a given time so that the selector 8 selects the output signal of the adder 5 as the filtered output signal 31, then the minimum value determiner 13 necessarily determines at the next time that the output value of the subtractor 11 outputs the minimum value. Because of this, the output signal of the adder 6 becomes the output signal 30 which is then output as the filtered output signal 31 which keeps thereby the same value through the successive time points. For this reason, in the case where the input data is rapidly changing as in the form of sinusoidal curve, the output waveform sometimes does not become smooth while noise is removed.

In contrast to this, in the present alternative embodiment, if the subtractor 10 outputs the minimum value, then the adder 5 outputs the output value 24 which is {filtered output signal 31+(output signal 21 of delay circuit 2+output signal 22 of delay circuit 3)/2}/2. In other words, whereas the adder 5 of the previous embodiment outputs, as the output signal 24, the average value of the output signals 21 and 22 of the delay circuits 2 and 3, the adder 5 of the alternative embodiment serves to adjust this output by subtracting therefrom the value of {(the average value of the output signals 21 and 23 of the delay circuits 2 and 3)/2−(the previous filtered output signal 31)/2}. The output signal 25 of the adder 6 is selected as the output signal 30 in synchronism with the next clock signal since the minimum value determiner 13 necessarily determines that the output value 28 of the subtractor 11 outputs the minimum value, unless the current input value is the previous input value or the twice previous input value. As a result, the filtered output signal 31 tends to change in a linear manner with the previous, current and next values as described above, so that it is possible to obtain the filtered output signal 31 in a smooth waveform as compared with the previous embodiment.

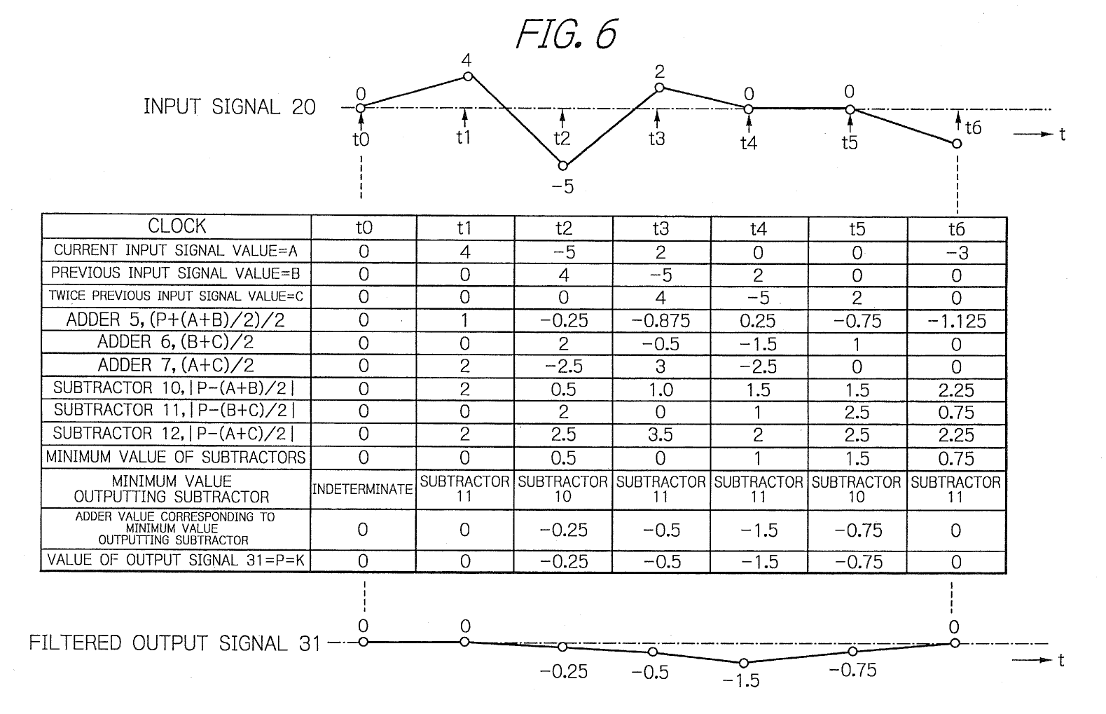

Next, the operation of the alternative embodiment will be described in detail with reference to FIG. 6. In the same figure, the same example of input signal 20 is used as the previous embodiment. Also, the filtered output signal 31 takes the same values at times t0 and t1 as the previous embodiment.

However, at time t2, the minimum value determiner 13 determines that the output value 27 of the subtractor 10 is the minimum value, i.e. 0.5. The minimum value determiner 13 then outputs to the selector 8 the value calculation subtractor identifier signal 32 indicating that the output value 27 of the subtractor 10 is the minimum value. The selector 8 receives the minimum value calculation subtractor identifier signal 32, and selects the output value K=−0.25 of the corresponding adder 5 as the output value 30. As compared with the adder 5 of the previous embodiment which outputs the output value K=−0.5, the output of the adder 5 of the alternative embodiment is adjusted by subtracting therefrom the value of {(the average value of the output signals 21 and 23 of the delay circuits 2 and 3)/2−(the previous filtered output signal 31)/2}, which is 0.25.

At time t3, the minimum value determiner 13 determines that the output value 28 of the subtractor 11 is “0” and the minimum value. The selector 8 receives the minimum value calculation subtractor identifier signal 32 indicating that the output value 28 of the subtractor 11 is the minimum value, and selects the output value K=−0.5 of the adder 6 as the output value 30. By this process, the previous filtered output signal 31 successively takes values of 0, −0.25 and −0.5 at times t1, t2 and t3 respectively in a smooth waveform. As a result, in the alternative embodiment, it is possible to obtain the filtered output signal 31 in a smoother waveform as than the previous embodiment in which the corresponding output values are 0, −0.5 and −0.5. At times t4, t5 and t6, it is possible to obtain the filtered output signal 31 in a smoother waveform than the previous embodiment in the same manner.

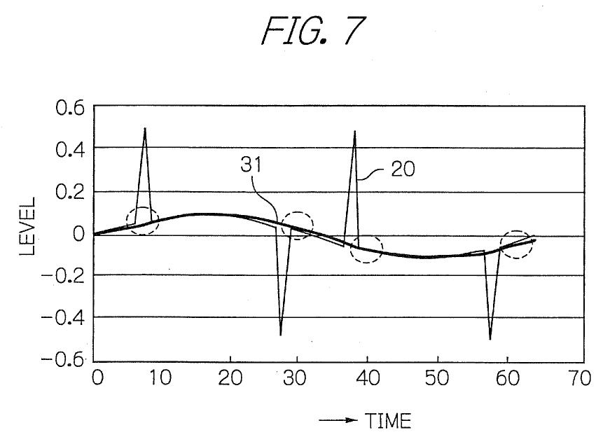

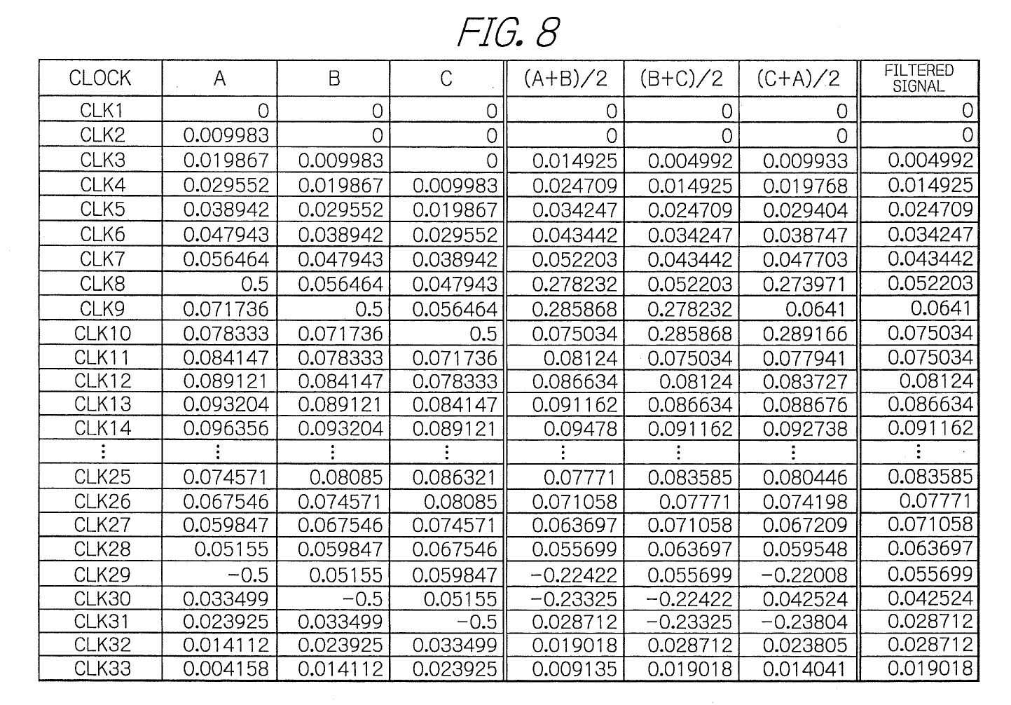

FIG. 7 plots the waveforms of an example of sinusoidal input signal 20 with noise superimposed and the corresponding filtered output signal 31 of the noise removing circuit 1 of the previous embodiment shown in and described with reference to FIG. 1. FIG. 8 shows the operational results of the noise removing circuit 1 of the previous embodiment in response to the same example of input signal 20 as FIG. 7 in respect of the output values A, B and C of the delay circuits 2, 3 and 4, and the average value of every two of these output values which are varying in synchronism with the clock signal.

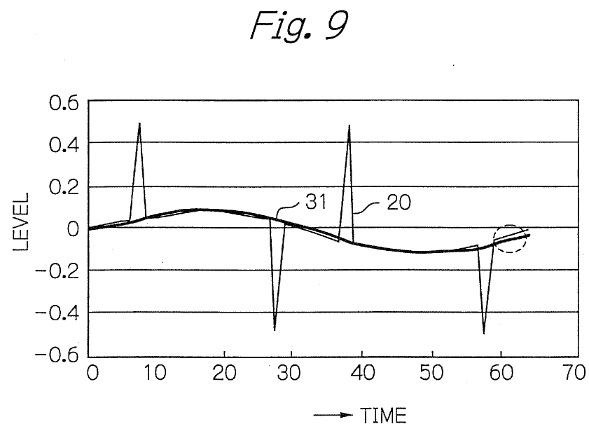

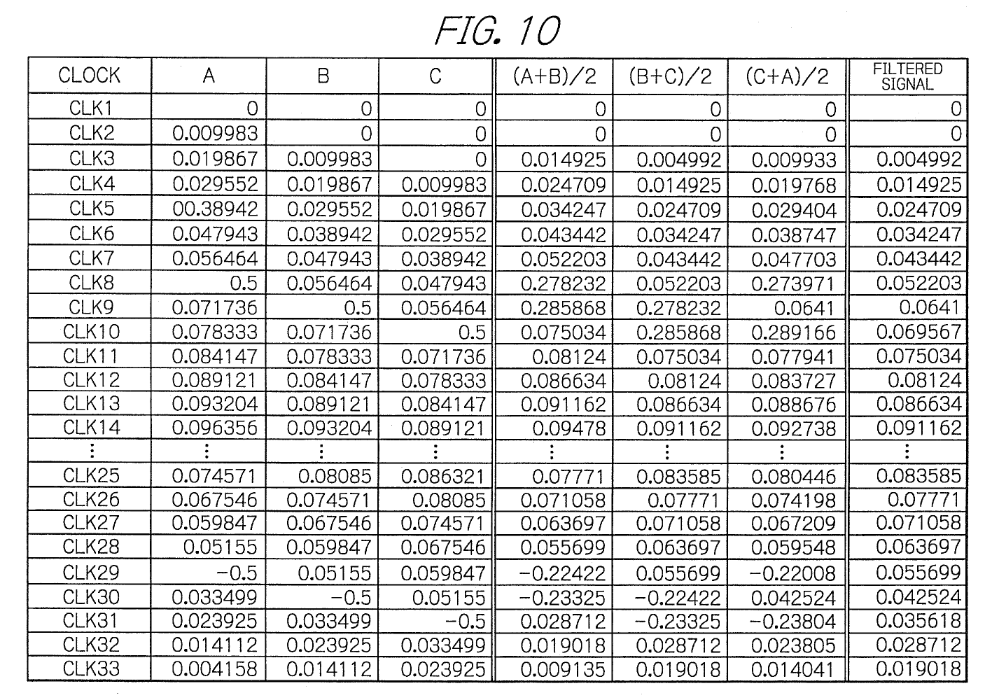

FIG. 9 plots the waveforms of the example of sinusoidal input signal 20 with noise superimposed and the corresponding filtered output signal 31 of the noise removing circuit 101 of the alternative embodiment illustrated in FIG. 5. FIG. 10 shows the operational results of the noise removing circuit 101 of the alternative embodiment in response to the same example of input signal 20 as FIG. 9, in respect of the output values A, B and C of the delay circuits 2, 3 and 4, and the average value of every two of these output values which are varying in synchronism with the clock signal. The input signal 20 given in FIGS. 9 and 10 are the same as FIGS. 7 and 8.

As illustrated in FIGS. 7 and 8, at clock time point CLK8, a pulse noise is superimposed on the sinusoidal input signal 20, and successively propagated from the delay circuit 2 (value A) to the delay circuit 3 (value B) and then to the delay circuit 4 (value C) at clock time points CLK9 and CLK10. The minimum value determiner 13 determines at clock time point CLK10 that the subtractor 10 outputs the minimum value (output signal 27), and the selector 8 selects the adder 5 and outputs the value K=0.075034 as the output signal 30. The output signal 30 becomes the filtered output signal 31. Next, at clock time point CLK11, the minimum value determiner 13 determines that the subtractor 11 outputs the minimum value (output signal 28), and the selector 8 selects the adder 6, and outputs the value K=0.075034 as the output signal 30. As a result, the filtered output signal takes the same value at clock time points CLK10 and CLK11. Accordingly, the filtered output signal does not smoothly vary from clock time points CLK9 to CLK11. The above discussion is substantially true also at clock time points CLK30, CLK31 and CLK32.

Next, the alternative embodiment will be considered with reference to FIGS. 9 and 10. The pulse noise is superimposed on the sinusoidal input signal 20 at clock time point CLK8, and successively propagated from the delay circuit 2 (value A) to the delay circuit 3 (value B) and then to the delay circuit 4 (value C) at clock time points CLK9 and CLK10 in the same manner as the previous embodiment. In the alternative embodiment, however, after the minimum value determiner 13 determines at clock time point CLK10 that the subtractor 10 outputs the minimum value (output signal 27), the selector 8 selects the adder 5 and outputs the value K=(0.0641+0.075034)/2 =0.069567 as the output signal 30. Next, at clock time point CLK11, the minimum value determiner 13 determines that the subtractor 11 outputs the minimum value (output signal 27), and the selector 8 selects the adder 6, and outputs the value K=0.075034 as the output signal 30. Accordingly, the filtered output signal 31 smoothly varies from clock time points CLK9 to CLK11. The above discussion is also the case with clock time points CLK30, CLK31 and CLK32.

As has been discussed above, in the embodiment shown in and described with reference to FIG. 1, the filtered output signal is output by calculating the average of every two of the three successive input values, determining which average is closest to the previous value of the filtered output signal, selecting one of the average values in accordance with the closest average value as determined, and outputting the selected average value as the value of the filtered output signal. By employing the above process, while the circuit configuration is relatively simple, it is possible not only to remove noise superimposed on one sample but also to remove noise superimposed on consecutive samples in an effective manner. In the embodiment shown in and described with reference to FIG. 5, also, it is possible not only to remove noise superimposed on one sample and noise superimposed on consecutive samples in an effective manner, but also to make the wave form of the filtered output signal 31 smooth. The former embodiment is particularly effective in the case where the original data itself significantly varies in synchronism with the clock signal even if no noise is imposed thereon.

In accordance with an aspect of the present invention, a filtering method of filtering an input signal and outputting a first output signal in synchronism with a clock signal, comprising: a first step of producing three signals which are delayed in relation to the input signal by respective periods corresponding to one clock, two clocks and three clocks, respectively, in synchronism with the clock signal; a second step of averaging every two of the three delayed signals to calculate three average values; a third step of calculating a difference of each of the three average values calculated in said second step from the first output signal to produce three differential values; a fourth step of determining which of the three differential values calculated in said third step is a minimum differential value to output a second output signal which indicates the average value corresponding to the minimum differential value; a fifth step of selecting one of the three average values which corresponds to the second output signal to output the selected average value as a third output signal; and a sixth step of outputting the third output signal as the first output signal in synchronism with the clock signal, whereby every two of the three delayed signals are averaged, and one of the average values is determined which is closest to the previous value of the first output signal, the average value determined being output as the current value of the first output signal.

In the filtering method, said second step includes: a first substep of calculating an average value by averaging two values of the input signal that are delayed by the periods corresponding to the one clock and the two clocks, respectively, to produced a first average value, and averaging the first average value and the first output signal to thereby output one of the three average values; a second substep of calculating an average value by averaging two values of the input signal that are delayed by the periods corresponding to the two clock and the three clocks, respectively, to thereby output another of the three average values; and a third step of calculating an average value by averaging two values of the input signal that are delayed by the periods corresponding to the one clock and the three clocks, respectively, to thereby output still another of the three average values.

The filtering method may further comprises a seventh step of calculating an absolute value of the difference of each of the three average values from the first output signal.

The entire disclosure of Japanese patent application No. 2007-187014 filed on Jul. 18, 2007, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A filter circuit for filtering an input signal in synchronism with a clock signal to output a first output signal, comprising:
a first delay circuit operative in synchronism with the clock signal to produce at least three signals which are delayed in relation to the input signal by respective periods corresponding to one clock, two clocks and three clocks respectively;
an average circuit averaging every two of the three delayed signals to calculate three average values;
a differential circuit operative to the first output signal for calculating a difference of each of the three average values calculated by said average circuit from the first output signal to produce three differential values;
a minimum value determination circuit determining which of the three differential values calculated by said differential circuit is a minimum differential value to output a second output signal which indicates the average value corresponding to the minimum differential value;
a selector selecting one of the three average values which corresponds to the second output signal to output the selected average value as a third output signal; and
a second delay circuit outputting the third output signal as the first output signal in synchronism with the clock signal,
whereby every two of the three delayed signals are averaged, and one of the average values is determined which is closest to the previous value of the first output signal, the averaged value determined being output as the current value of the first output signal.

2. The filter circuit as claimed in claim 1, wherein said average circuit includes three adders, wherein
one of said three adders averages two values of the input signal that are delayed by the periods corresponding to the one clock and the two clocks, respectively, to produce a first average value, and averages the first average value and the first output signal to thereby output one of the three average values,
another of said three adders averaging two values of the input signal delayed by the periods corresponding to the one clock and the three clocks, respectively, to thereby output another of the three average values,
still another of said three adders averaging two values of the input signal delayed by the periods corresponding to the two clocks and the three clocks, respectively, to thereby output still another of the three average values.

3. The filter circuit as claimed in claim 1, wherein said differential circuit calculates an absolute value of the difference of each of the three average values from the value of the first output signal.

4. A filter circuit for removing noise from digital input data in a form of series of sampled values to produce digital output data in the form of series of filtered values, comprising:
a delay unit successively receiving the sampled values to output a current, previous and twice previous values at each time in synchronism with a sampling clock;
an average circuit receiving the current, previous and twice previous values to calculate an average value of every two of the current, previous and twice previous values to output the three average values calculated;
a determination circuit determining one of the three average values that is closest to the previous filtered value of the digital output data at each time in synchronism with a sampling clock; and
an output circuit calculating the filtered value of the digital output data by performing an averaging operation of the sampled values of which the closest average value is calculated.

5. The filter circuit as claimed in claim 4, wherein said average circuit performs the averaging operation together with the previous filtered value.
